(19) United States
(12) Patent Application Publication
(10) Pub. No.: US 2026/0112267 A1
(43) Pub. Date: Apr. 23, 2026

(54) AUTONOMOUS TRANSIT VEHICLE OPERATION SYSTEM FOR ADVERSE WEATHER AND LONG-TAIL SCENARIOS

(71) Applicant: CAVH LLC, Fitchburg, WI (US)

(72) Inventors: Bin Ran, Fitchburg, WI (US); Yang Cheng, Middleton, WI (US); Xiaoli Zhang, Madison, WI (US); Haiyan Yu, Madison, WI (US); Yi Shen, Madison, WI (US); Shaohua Wang, Madison, WI (US); Yanyan Qin, Madison, WI (US); Liling Zhu, Madison, WI (US); Hongliang Wan, Madison, WI (US); Yangxin Lin, Fitchburg, WI (US); Shiyan Xu, Madison, WI (US); Hainan Huang, Madison, WI (US); Kun Luan, Madison, WI (US); Hongli Gao, Madison, WI (US); Linfeng Zhang, Madison, WI (US); Yuanyuan Zhang, Fitchburg, WI (US); Yihui Yang, Fitchburg, WI (US)

(21) Appl. No.: 19/414,665

(22) Filed: Dec. 10, 2025

Related U.S. Application Data
(63) Continuation of application No. 16/505,059, filed on Jul. 8, 2019.
(60) Provisional application No. 62/696,046, filed on Jul. 10, 2018.

(51) Int. Cl. G08G 1/07; E01F 15/02; G05D 1/00; G06Q 30/0283; G08G 1/01; G08G 1/052; G08G 1/09; G08G 1/123; H04L 67/10

(52) U.S. Cl. CPC G08G 1/07; E01F 15/02; G08G 1/0125; G08G 1/052; G08G 1/091; G08G 1/123; G06Q 30/0283; H04L 67/10

(57) ABSTRACT

The technology provides designs and methods for the transit management system, which facilitates transit vehicle operations and control for connected automated transit vehicles (CATVs) systems. The transit management system provides transit vehicles with customized/non-customized information and time-sensitive control instructions for transit vehicle to fulfill the driving tasks such as vehicle routing, lane changing, turning. The transit management system also realizes transit vehicle lane design, transportation operations and management services for transit vehicle. The transit management system consists of one of more of the following physical subsystems: (1) Roadside Unit (RSU) network, (2) Traffic Control Unit (TCU) and Traffic Control Center (TCC) network, (3) Vehicle Onboard Unit (OBU), (4) Traffic Operations Centers (TOCs), (5) Cloud platform. The transit management system realizes one or more of the following function categories: sensing, transportation behavior prediction and management, planning and decision making, and vehicle control. The transit management system is supported by road infrastructure, real-time wired and/or wireless communication, the power supply networks, and cyber safety and security services.

This application is a continuation of U.S. patent application Ser. No. 16/505,059, filed Jul. 8, 2019, which claims the benefit of U.S. Provisional Application No. 62/696,046 , filed Jul. 10, 2018, each of which is incorporated herein by reference in its entirety.

### FIELD

The present technology relates generally to a comprehensive system providing full vehicle operations and control for connected and automated transit vehicles, and, more particularly, to a system controlling CATVs by sending individual vehicles with detailed and time-sensitive control instructions for vehicle routing, lane changing, turning, and related information.

### BACKGROUND

Transit management systems, in which transit vehicles are detected and navigated by roadside units without or with reduced human input, are in development. At present, they are in experimental testing and not in widespread commercial use. Existing systems and methods are mostly expensive and complicated, making widespread implementation a substantial challenge. Alternative systems and methods that address these problems are described in U.S. patent application Ser. No. 14/714,642, filed May 18, 2015, and Ser. No. 15/429,261, filed Feb. 10, 2017, each of which is herein incorporated by reference (referred to herein as a CAVH system).

### SUMMARY

In some embodiments, the present technology relates generally to a comprehensive system providing full vehicle operations and control for connected and automated transit vehicles, and, more particularly, to a system controlling CATVs by sending individual vehicles with detailed and time-sensitive control instructions for vehicle routing, lane changing, turning, and related information.

In some embodiments, the technology provides systems and methods for a transit management system which promotes transit vehicle operations and control in a connected automated transit vehicle environment. Connected and automated transit vehicle systems and methods provide transit vehicles with customized/non-customized information and time-sensitive control instructions for vehicle to fulfill the driving tasks such as vehicle routing, lane changing, turning and route guidance. Connected and automated transit vehicle systems and methods also manage transportation operations and management services for freeways. In some embodiments, the technology improves previous technologies, e.g., platoon control methods designed to manage vehicles traveling on a controlled roadway by virtual moving packets (see, e.g., U.S. Pat. No. 9,595,190). In some embodiments, the present technology also improves previous technologies such as autonomous vehicle assisting systems designed to increase safety and consumer satisfaction with autonomous vehicles and help bridge the gap towards completely autonomy (see, e.g., U.S. Pat. No. 9,964,948).

In some embodiments, the technology comprises a connected automated vehicle highway system and methods and/or components thereof as described in U.S. patent application Ser. No. 15/628,331, filed Jun. 20, 2017 and U.S. Provisional Patent Application Ser. No. 62/626,862, filed Feb. 6, 2018, U.S. Provisional Patent Application Ser. No. 62/627,005, filed Feb. 6, 2018, U.S. Provisional Patent Application Ser. No. 62/655,651, filed Apr. 10, 2018, and U.S. Provisional Patent Application Ser. No. 62/669,215, filed May 9, 2018, the disclosures of each of which is herein incorporated by reference in its entirety (referred to herein as a CAVH system).

In some embodiments, the technology relates to the use of a connected automated vehicle highway system and methods and/or components thereof for heavy and special vehicles, e.g., as described in U.S. Provisional Patent Application Ser. No. 62/687,435, filed Jun. 20, 2018, which is incorporated herein by reference. In some embodiments, the technology comprises a cloud system as described in U.S. Provisional Patent Application Ser. No. 62/691,391, incorporated herein by reference in its entirety. In some embodiments, the technology comprises technologies related to safety systems as described in U.S. Provisional Patent Application Ser. No. 62/695,938, incorporated herein by reference in its entirety. In some embodiments, the technology comprises technologies related to an on-board unit (OBU) as described in U.S. Provisional Patent Application Ser. No. 62/695,964, incorporated herein by reference in its entirety.

In some embodiments, the technology provides safety technologies as described herein and a vehicle operations and control system comprising one or more of a roadside unit (RSU) network; a Traffic Control Unit (TCU) and Traffic Control Center (TCC) network (e.g., TCU/TCC network); a vehicle comprising an onboard unit (OBU), e.g., as described herein; and/or a Traffic Operations Center (TOC).

In some embodiments, the technology provides a system (e.g., a vehicle operations and control system comprising a RSU network; a TCU/TCC network; a vehicle comprising an onboard unit OBU; a TOC; and a cloud-based platform configured to provide information and computing services; see, e.g., U.S. Provisional Patent Application Ser. No. 62/691,391, incorporated herein by reference in its entirety) configured to provide sensing functions, transportation behavior prediction and management functions, planning and decision making functions, and/or vehicle control functions. In some embodiments, the system comprises wired and/or wireless communications media. In some embodiments, the system comprises a power supply network. In some embodiments, the system comprises a cyber-safety and security system. In some embodiments, the system comprises a real-time communication function.

In some embodiments, the RSU network of embodiments of the systems provided herein comprises an RSU subsystem. In some embodiments, the RSU subsystem comprises: a sensing module configured to measure characteristics of the driving environment; a communication module configured to communicate with vehicles, TCUs, and the cloud; a data processing module configured to process, fuse, and compute data from the sensing and/or communication modules; an interface module configured to communicate between the data processing module and the communication module; and an adaptive power supply module configured to provide power and to adjust power according to the conditions of the local power grid. In some embodiments, the adaptive power supply module is configured to provide backup redundancy. In some embodiments, communication module communicates using wired or wireless media.

In some embodiments, sensing module comprises a radar based sensor. In some embodiments, sensing module comprises a vision based sensor. In some embodiments, sensing module comprises a radar based sensor and a vision based sensor and wherein said vision based sensor and said radar based sensor are configured to sense the driving environment and vehicle attribute data. In some embodiments, the radar based sensor is a LIDAR, microwave radar, ultrasonic radar, or millimeter radar. In some embodiments, the vision based sensor is a camera, infrared camera, or thermal camera. In some embodiments, the camera is a color camera.

In some embodiments, the sensing module comprises a satellite based navigation system. In some embodiments, the sensing module comprises an inertial navigation system. In some embodiments, the sensing module comprises a satellite based navigation system and an inertial navigation system and wherein said sensing module comprises a satellite based navigation system and said inertial navigation system are configured to provide vehicle location data. In some embodiments, the satellite based navigation system is a Differential Global Positioning Systems (DGPS) or a BeiDou Navigation Satellite System (BDS) System or a GLONASS Global Navigation Satellite System. In some embodiments, the inertial navigation system comprises an inertial reference unit.

In some embodiments, the sensing module of embodiments of the systems described herein comprises a vehicle identification device. In some embodiments, the vehicle identification device comprises RFID, Bluetooth, Wi-fi (IEEE 802.11), or a cellular network radio, e.g., a 4G or 5G cellular network radio.

In some embodiments, the RSU sub-system is deployed at a fixed location near road infrastructure. In some embodiments, the RSU sub-system is deployed near a highway roadside, a highway on ramp, a highway off ramp, an interchange, a bridge, a tunnel, a toll station, or on a drone over a critical location. In some embodiments, the RSU sub-system is deployed on a mobile component. In some embodiments, the RSU sub-system is deployed on a vehicle drone over a critical location, on an unmanned aerial vehicle (UAV), at a site of traffic congestion, at a site of a traffic accident, at a site of highway construction, at a site of extreme weather. In some embodiments, a RSU sub-system is positioned according to road geometry, heavy vehicle size, heavy vehicle dynamics, heavy vehicle density, and/or heavy vehicle blind zones. In some embodiments, the RSU sub-system is installed on a gantry (e.g., an overhead assembly, e.g., on which highway signs or signals are mounted). In some embodiments, the RSU sub-system is installed using a single cantilever or dual cantilever support.

In some embodiments, the TCC network of embodiments of the systems described herein is configured to provide traffic operation optimization, data processing and archiving. In some embodiments, the TCC network comprises a human operations interface. In some embodiments, the TCC network is a macroscopic TCC, a regional TCC, or a corridor TCC based on the geographical area covered by the TCC network. See, e.g., U.S. Patent Application Ser. No. 15/628,331, filed Jun. 20, 2017 and U.S. Provisional Patent Application Ser. No. 62/626,862, filed Feb. 6, 2018, U.S. Provisional Patent Application Ser. No. 62/627,005, filed Feb. 6, 2018, U.S. Provisional Patent Application Ser. No. 62/655,651, filed Apr. 10, 2018, and U.S. Provisional Patent Application Ser. No. 62/669,215, filed May 9, 2018, each of which is incorporated herein in its entirety for all purposes.

In some embodiments, the TCU network is configured to provide real-time vehicle control and data processing. In some embodiments, the real-time vehicle control and data processing are automated based on preinstalled algorithms.

In some embodiments, the TCU network is a segment TCU or a point TCUs based on based on the geographical area covered by the TCU network. See, e.g., U.S. patent application Ser. No. 15/628,331, filed Jun. 20, 2017 and U.S. Provisional Patent Application Ser. No. 62/626,862, filed Feb. 6, 2018, U.S. Provisional Patent Application Ser. No. 62/627,005, filed Feb. 6, 2018, U.S. Provisional Patent Application Ser. No. 62/655,651, filed Apr. 10, 2018, and U.S. Provisional Patent Application Ser. No. 62/669,215, filed May 9, 2018, each of which is incorporated herein in its entirety for all purposes. In some embodiments, the system comprises a point TCU physically combined or integrated with an RSU. In some embodiments, the system comprises a segment TCU physically combined or integrated with a RSU.

In some embodiments, the TCC network of embodiments of the systems described herein comprises macroscopic TCCs configured to process information from regional TCCs and provide control targets to regional TCCs; regional TCCs configured to process information from corridor TCCs and provide control targets to corridor TCCs; and corridor TCCs configured to process information from macroscopic and segment TCUs and provide control targets to segment TCUs. See, e.g., U.S. patent application Ser. No. 15/628,331, filed Jun. 20, 2017 and U.S. Provisional Patent Application Ser. No. 62/626,862, filed Feb. 6, 2018, U.S. Provisional Patent Application Ser. No. 62/627,005, filed Feb. 6, 2018, U.S. Provisional Patent Application Ser. No. 62/655,651, filed Apr. 10, 2018, and U.S. Provisional Patent Application Ser. No. 62/669,215, filed May 9, 2018, each of which is incorporated herein in its entirety for all purposes.

In some embodiments, the TCU network comprises: segment TCUs configured to process information from corridor and/or point TOCs and provide control targets to point TCUs; and point TCUs configured to process information from the segment TCU and RSUs and provide vehicle-based control instructions to an RSU. See, e.g., U.S. patent application Ser. No. 15/628,331, filed Jun. 20, 2017 and U.S. Provisional Patent Application Ser. No. 62/626,862, filed Feb. 6, 2018, U.S. Provisional Patent Application Ser. No. 62/627,005, filed Feb. 6, 2018, U.S. Provisional Patent Application Ser. No. 62/655,651, filed Apr. 10, 2018, and U.S. Provisional Patent Application Ser. No. 62/669,215, filed May 9, 2018, each of which is incorporated herein in its entirety for all purposes.

In some embodiments, the RSU network of embodiments of the systems provided herein provides vehicles with customized traffic information and control instructions and receives information provided by vehicles.

In some embodiments, the TCC network of embodiments of the systems provided herein comprises one or more TCCs comprising a connection and data exchange module configured to provide data connection and exchange between TCCs. In some embodiments, the connection and data exchange module comprises a software component providing data rectify, data format convert, firewall, encryption, and decryption methods. In some embodiments, the TCC network comprises one or more TCCs comprising a transmission and network module configured to provide communication methods for data exchange between TCCs. In some embodiments, the transmission and network module comprises a software component providing an access function and data conversion between different transmission networks within the cloud platform. In some embodiments, the TCC network comprises one or more TCCs comprising a service management module configured to provide data storage, data searching, data analysis, information security, privacy protection, and network management functions. In some embodiments, the TCC network comprises one or more TCCs comprising an application module configured to provide management and control of the TCC network. In some embodiments, the application module is configured to manage cooperative control of vehicles and roads, system monitoring, emergency services, and human and device interaction.

In some embodiments, TCU network of embodiments of the systems described herein comprises one or more TCUs comprising a sensor and control module configured to provide the sensing and control functions of an RSU. In some embodiments, the sensor and control module is configured to provide the sensing and control functions of radar, camera, RFID, and/or V2I (vehicle-to-infrastructure) equipment. In some embodiments, the sensor and control module comprises a DSRC, GPS, 4G, 5G, and/or wifi radio. In some embodiments, the TCU network comprises one or more TCUs comprising a transmission and network module configured to provide communication network function for data exchange between an automated heavy vehicles and a RSU. In some embodiments, the TCU network comprises one or more TCUs comprising a service management module configured to provide data storage, data searching, data analysis, information security, privacy protection, and network management. In some embodiments, the TCU network comprises one or more TCUs comprising an application module configured to provide management and control methods of an RSU. In some embodiments, the management and control methods of an RSU comprise local cooperative control of vehicles and roads, system monitoring, and emergency service. In some embodiments, the TCC network comprises one or more TCCs further comprising an application module and said service management module provides data analysis for the application module. In some embodiments, the TCU network comprises one or more TCUs further comprising an application module and said service management module provides data analysis for the application module.

In some embodiments, the TOC of embodiments of the systems described herein comprises interactive interfaces. In some embodiments, the interactive interfaces provide control of said TCC network and data exchange. In some embodiments, the interactive interfaces comprise information sharing interfaces and vehicle control interfaces. In some embodiments, the information sharing interfaces comprise: an interface that shares and obtains traffic data; an interface that shares and obtains traffic incidents; an interface that shares and obtains passenger demand patterns from shared mobility systems; an interface that dynamically adjusts prices according to instructions given by said vehicle operations and control system; and/or an interface that allows a special agency (e.g., a vehicle administrative office or police) to delete, change, and share information. In some embodiments, the vehicle control interfaces of embodiments of the interactive interfaces comprise: an interface that allows said vehicle operations and control system to assume control of vehicles; an interface that allows vehicles to form a platoon with other vehicles; and/or an interface that allows a special agency (e.g., a vehicle administrative office or police) to assume control of a vehicle. In some embodiments, the traffic data comprises vehicle density, vehicle velocity, and/or vehicle trajectory. In some embodiments, the traffic data is provided by the vehicle operations and control system and/or other share mobility systems. In some embodiments, traffic incidents comprise extreme conditions, major accident, and/or a natural disaster. In some embodiments, an interface allows the vehicle operations and control system to assume control of vehicles upon occurrence of a traffic event, extreme weather, or pavement breakdown when alerted by said vehicle operations and control system and/or other share mobility systems. In some embodiments, an interface allows vehicles to form a platoon with other vehicles when they are driving in the same dedicated and/or same non-dedicated lane.

In some embodiments, the OBU of embodiments of systems described herein comprises a communication module configured to communicate with an RSU. In some embodiments, the OBU comprises a communication module configured to communicate with another OBU. In some embodiments, the OBU comprises a data collection module configured to collect data from external vehicle sensors and internal vehicle sensors; and to monitor vehicle status and driver status. In some embodiments, the OBU comprises a vehicle control module configured to execute control instructions for driving tasks. In some embodiments, the driving tasks comprise car following and/or lane changing. In some embodiments, the control instructions are received from an RSU. In some embodiments, the OBU is configured to control a vehicle using data received from an RSU. In some embodiments, the data received from said RSU comprises: vehicle control instructions; travel route and traffic information; and/or services information. In some embodiments, the vehicle control instructions comprise a longitudinal acceleration rate, a lateral acceleration rate, and/or a vehicle orientation. In some embodiments, the travel route and traffic information comprise traffic conditions, incident location, intersection location, entrance location, and/or exit location. In some embodiments, the services data comprises the location of a fuel station and/or location of a point of interest. In some embodiments, OBU is configured to send data to an RSU. In some embodiments, the data sent to said RSU comprises: driver input data; driver condition data; vehicle condition data; and/or goods condition data. In some embodiments, the driver input data comprises origin of the trip, destination of the trip, expected travel time, service requests, and/or level of hazardous material. In some embodiments, the driver condition data comprises driver behaviors, fatigue level, and/or driver distractions. In some embodiments, the vehicle condition data comprises vehicle ID, vehicle type, and/or data collected by a data collection module. In some embodiments, the goods condition data comprises material type, material weight, material height, and/or material size.

In some embodiments, the OBU of embodiments of systems described herein is configured to collect data comprising: vehicle engine status; vehicle speed; goods status; surrounding objects detected by vehicles; and/or driver conditions. In some embodiments, the OBU is configured to assume control of a vehicle. In some embodiments, the OBU is configured to assume control of a vehicle when the automated driving system fails. In some embodiments, the OBU is configured to assume control of a vehicle when the vehicle condition and/or traffic condition prevents the automated driving system from driving said vehicle. In some embodiments, the vehicle condition and/or traffic condition is adverse weather conditions, a traffic incident, a system failure, and/or a communication failure.

Accordingly, in some embodiments, the technology provides a transit management system configured to provide integrated operations and controls for connected and automated transit vehicles (CATVs). In some embodiments, the transit management system is configured to provide customized mobility service and non-customized mobility service. In some embodiments, the transit management system is configured to send detailed and time-sensitive control instructions individual vehicles. In some embodiments, said control instructions include vehicle routing, lane changing, and turning. In some embodiments, the transit management system comprises a roadside unit (RSU) network; a Traffic Control Unit (TCU) and Traffic Control Center (TCC) network; Vehicle onboard units (OBU) and vehicle interfaces; Traffic operations centers (TOC); and a cloud-based platform of information and computing services.

In some embodiments, the transit management system is configured to communicate in real-time via wired and wireless media. In some embodiments, the transit management system is configured to obtain power from a power supply network. In some embodiments, the transit management system is configured to communicate with a cyber safety and security system. In some embodiments, the transit management system is configured to provide sensing, transportation behavior prediction and management, planning and decision making, and vehicle control. In some embodiments, the transit management system is configured to be operational on one or more lanes. In some embodiments, the transit management system is configured to be operational on urban streets and access controlled freeways. In some embodiments, the transit management system comprises physical and/or logical barriers to separate lanes. In some embodiments, the transit management system comprises physical and/or logical barriers to separate CAVH lanes from conventional lanes used by human-driven vehicles. In some embodiments, the logic barriers comprise pavement markings and/or signs to separate bus lanes from other lanes. In some embodiments, the physical barriers comprise fences and/or lowered pavement to separate bus lanes from other lanes.

In some embodiments, the transit management system comprises a bus stop configuration that is a non-dedicated bus stop or a dedicated CATV bus stop. In some embodiments, the transit management system comprises a bus stop configuration that is a curbside stop or a bus bay stop. In some embodiments, the transit management system comprises a bus stop located near an intersection, far from an intersection, or in mid-block.

In some embodiments, the transit management system comprises one or more non-dedicated lanes, one or more dedicated CATV lanes, and one or dynamic CATV-only lanes. In some embodiments, the transit management system comprises one or more dynamic lanes that are CATV-only during peak traffic times. In some embodiments, the transit management system is configured to manage vehicle priority management at intersections and diverging/merging locations based on the total delay and the average vehicle speed.

In some embodiments, the transit management system comprises CATVs. In some embodiments, said CATVs are configured to send vehicle operation status information to RSUs via I2V communication. In some embodiments, the transit management system said vehicle operation status information comprises passenger conditions, vehicle position, speed, delay time, timetable, origin-destination (OD), and vehicle status.

In some embodiments, the transit management system is configured to provide vehicle stop management methods. In some embodiments, the vehicle stop management methods comprise Determining a stop platform for an inbound automatic transit vehicle; Detecting whether a bus stop platform for an automatic transit vehicle is appropriate; Detecting the state of the automatic transit vehicle door as open or closed; Detecting completion of passenger onboarding and/or passenger offloading; Coordinating entry order and stop points for arriving automated transit vehicles; and/or Producing warnings and adjusting an abnormal state of an automated transit vehicle.

In some embodiments, the transit management system is configured to provide customized mobility service and non-customized mobility service. In some embodiments, the customized mobility service provides customized travel plans, dispatch of automated transit vehicles, passenger pick up, and passenger drop off based on individual passenger travel requests. In some embodiments, passenger travel requests comprise requests for starting points of travel, ending points of travel, and travel time. In some embodiments, the non-customized mobility service provides an automated transit vehicle service with fixed schedules and routes.

In some embodiments, the transit management system is configured to provide terminal control methods comprising identifying an automated transit vehicle; releasing a vehicle; intercepting an unauthorized vehicle; inspecting and maintaining a vehicle; refueling and/or charging a vehicle; parking a vehicle; and/or providing customized maintenance procedures for private and third party vehicles.

In some embodiments, the transit management system comprises an RSU comprising a plurality of modules and/or sub-modules. In some embodiments, the RSU comprises a sensing module configured detecting the transit driving environment; a communication module configured to communicate with transit vehicles, TCUs, and cloud via wired or wireless media; a data processing module configured to processes, fuse, and compute data from the sensing and communication module; an interface module configured to communicate between the data processing module and the communication module; an adaptive power supply module configured to adjust power delivery according to the conditions of the local power grid and provide backup redundancy; a station management module configured to monitor stations, detect passenger behavior, and control transit vehicles; and/or an intersection management module configured to monitor pedestrians and control transit vehicles based on traffic conditions at intersections. In some embodiments, the sensing module comprises radar based sensors, vision based sensors, a satellite navigation subsystem, an inertial navigation subsystem, and/or a vehicle identification device. In some embodiments, the radar based sensors are configured to communicate with a vision sensor to monitor road environment and vehicle attribute data. In some embodiments, the radar based sensors comprise one or more of LiDAR, Microwave radar, Ultrasonic radar, and/or Millimeter radar. In some embodiments, the vision based sensors are configured to communicate with a radar based sensor to provide road environment and traffic data. In some embodiments, the vision based sensors comprise one or more of a color high definition camera; infrared camera; thermal camera; and/or a drone camera. In some embodiments, the satellite navigation subsystem is configured to communicate with an inertial navigation system to support vehicle locating. In some embodiments, the satellite navigation subsystem comprises a DGPS or BeiDou system. In some embodiments, the inertial navigation subsystem is configured to communicate with a satellite navigation system to support vehicle locating. In some embodiments, the inertial navigation subsystem comprises an inertial reference unit. In some embodiments, the vehicle identification device comprises RFID, BLUETOOTH, Wifi (IEEE 802.11), and/or a cellular network component.

In some embodiments, RSUs of said RSU network are deployed at the roadside, at bus stops, at intersections, at diverging/merging point, at a bend in a road, at a bridges, in a tunnel, at an interchange, and/or on a drone over critical locations. In some embodiments, RSUs of said RSU network are deployed at a location of traffic congestion, traffic accident, road construction, and/or extreme weather. In some embodiments, RSUs of said RSU network are deployed according to spacing and layout factors comprising road geometry, road environment, pedestrian movement, bus stop environment and passengers, transit vehicle size, transit vehicle dynamics, and/or transit vehicle blind zone. In some embodiments, RSUs of said RSU network are installed using single cantilever or dual cantilevers.

In some embodiments, the transit management system comprises a TCC and TCU sub-system configured to perform TCC methods comprising optimizing transit traffic operations, processing data, providing memory management, and providing operation interfaces for a human. In some embodiments, the TCC and TCU sub-system comprises a macroscopic TCC, regional TCC, and/or corridor TCC based on the transit control area. In some embodiments, the TCC and TCU sub-system is configured to perform TCU methods comprising controlling transit vehicles in real-time and processing data. In some embodiments, the TCU methods which are highly automated based on preinstalled algorithms. In some embodiments, the TCC and TCU sub-system comprises one or more segment TCU and/or point TCU based on coverage areas. In some embodiments, the TCC and TCU sub-system comprises one or more segment TCU and/or point TCU physically combined or integrated with a RSU. In some embodiments, the TCC and TCU sub-system comprises Macroscopic TCCs configured to process information from regional TCCs and provide control targets to regional TCCs; Regional TCCs configured to process information from corridor TCCs and provide control targets to corridor TCCs; Corridor TCCs configured to process information from Macroscopic and segment TCUs and provide control targets to segment TCUs; Segment TCUs configured to process information from corridor and/or point TOCs and provide control targets to point TCUs; and Point TCUs configured to process information from the segment TCU and RSUs and provide vehicle-based control instructions to RSU.

In some embodiments, RSUs provide transit vehicles with customized traffic information and control instructions and receive information provided by transit vehicles. In some embodiments, the TCC network systems comprise a connect and data exchange module, a service management module, an application module, and/or a transmission module. In some embodiments, the connect and data exchange module is configured to provide data exchange between different TCCs. In some embodiments, the connect and data exchange module is configured to provide data exchange between Macroscopic, Regional, and Corridor TCCs. In some embodiments, the connect and data exchange module comprises a software component configured to rectify data, convert data format, provide a firewall, encrypt data, and decrypt data. In some embodiments, the transmission module is configured to provide communication methods for data exchange between different TCCs. In some embodiments, the transmission module comprises wireless and wired hardware and software. In some embodiments, the transmission module comprises software configured to provide data access and data conversion between different transmission networks within the cloud platform. In some embodiments, the service management module is configured to provide data storage, data searching, data analysis for the application layer. In some embodiments, the service management module is configured to provide information security, privacy protection, and network management functions. In some embodiments, the application module is configured to provide management and control of the TCC. In some embodiments, the application module is configured to control vehicles, monitor roads, provide emergency service, and manage human-device interaction.

In some embodiments, the TCU network systems comprise a sensor and control module configured to provide sensing and control functions; a communication module configured to provide communication network functions for data exchange between automated transit vehicles and RSU; a service management module configured to provide data storage, data searching, data analysis, information security, privacy protection, and network management for the application layer; and/or an application module configured to provide management and control methods for controlling local vehicles, monitoring local roads, and providing local emergency service.

In some embodiments, the TOC comprises an interactive GUI component and provides an API for interfacing and data exchange. In some embodiments, the TOC comprises information sharing interfaces and vehicle control interfaces. In some embodiments, the sharing interfaces and vehicle control interfaces comprise an interface configured to share and obtain traffic data; an interface configured to share and obtain traffic incidents; an interface configured to share and obtain passenger demand patterns from other share mobility systems; an interface configured to adjust price dynamically according to instructions given by the automated bus system; an interface configured to allow special agencies to delete, change, and share information; an interface configured to allow the automated bus system to take control of vehicles under certain circumstances; an interface configured to allow vehicles to form a platoon with other SMSPs vehicle when they are driving in the same dedicated/non-dedicated lane; an interface configured to allow special agencies to take control of a vehicle under extreme conditions; an interface configured to allow an automated transit system to take control of vehicles when vehicles depart from a platform; and/or an interface configured to allow an automated transit system to take control of vehicles when vehicles arrive at a platform.

In some embodiments, traffic data comprise bus density, velocity, and trajectory. In some embodiments, traffic data are received from the automated bus system and/or other share mobility systems. In some embodiments traffic incidents comprise traffic events, extreme weather, and pavement breakdown. In some embodiments, traffic incidents data are received from the automated bus system and/or other share mobility systems. In some embodiments, special agencies comprise a vehicle administrative office or police.

In some embodiments, the transit management system is configured to perform scheduling and dispatching methods for non-customized and customized transit services.

In some embodiments, the technology provides an vehicle onboard unit (OBU) subsystem comprising a communication module configured to communicate with OBUs, RSUs, and transit vehicles; a data collection module configured to collect data from transit vehicles and to monitor the status of the transit vehicles, passengers, and drivers; and/or a transit vehicle control module configured to execute control instructions from RSU. In some embodiments, the vehicle onboard units (OBU) subsystem is configured to assist the RSU for controlling a transit vehicle. In some embodiments, the vehicle onboard units (OBU) subsystem is configured to receive data from RSU and/or send data to RSU; collect data; and/or take control of a vehicle in certain special circumstances. In some embodiments, the OBU receives data from RSU comprising transit vehicles control instructions, travel route and traffic information, and/or services data. In some embodiments, transit vehicles control instructions comprise longitudinal and lateral acceleration rate and vehicle direction. In some embodiments, travel route and traffic information comprises traffic conditions, accidents, intersections, and/or entrances and exits. In some embodiments, services data comprises location and information for fuel stations and/or points of interest. In some embodiments, an OBU sends data to RSU comprising driver input data, driver status data, and transit vehicle condition data. In some embodiments, driver input data comprises origin-destination of the trip, expected travel time, service requests, and/or level of hazardous materials in cargo. In some embodiments, driver status data comprises driver behaviors, fatigue level, and/or driver distractions. In some embodiments, transit vehicles condition data comprises vehicle ID, vehicle type, and data collected by the data collection module. In some embodiments, an OBU collects data comprising Transit vehicles engine state; Transit vehicles speed; Passenger status; Dangerous goods data; Surrounding objects detected by vehicles; and/or Driver conditions. In some embodiments, special circumstances include, e.g., adverse weather conditions, a traffic accident; or a communication failure.

In some embodiments, the transit management system comprises a cloud platform configured to communicate with application services and to process automated transit vehicle data. In some embodiments, the cloud platform comprises a cloud platform architecture and cloud operating system. In some embodiments, the cloud platform is configured to perform methods for data storage and retrieval, deep data mining, and data association and analysis In some embodiments, the cloud platform is configured to provide information and computing services comprising, e.g., Storage as a service (STaaS) configured to provide storage; Control as a service (CCaaS) configured to provide control capabilities; Computing as a service (CaaS) configured to provide computing resources; and/or Sensing as a service (SEaaS) configured to provide sensing capability. In some embodiments, the cloud platform is configured to estimate and predict traffic state. In some embodiments, the cloud platform is configured to perform a method for estimating and predicting traffic state comprising estimating the traffic state based on a weighted data fusion method, wherein the weights of data are determined by: (1) the quality of information provided by the sensors of RSU, TCC/TCU, and/or TOC; and/or whether information provided by the sensors of RSU, TCC/TCU, and/or TOC results from partial or complete detection. In some embodiments, the cloud platform is configured to communicate, exchange, and share data in real-time with vehicles, TCC/TCU network, the cloud, and other entities. In some embodiments, the cloud platform is configured to provide information to a transit vehicle for a specific route, bus stop, lane configuration, and/or traffic conditions.

In some embodiments, the transit management system is configured to perform special sensing methods for dedicated lanes and non-dedicated lanes. In some embodiments, special sensing methods for dedicated lanes comprise monitoring an automated transit vehicle using an OBU of said automated transit vehicle and a roadside RSU. In some embodiments, special sensing methods for dedicated lanes comprise collecting information, processing information, processing information, fusing information, sending information to the TCC/TCU network, and/or sharing information through the cloud platform. In some embodiments, special sensing methods for non-dedicated lanes comprise monitoring automated and non-automated vehicles by roadside RSUs and monitoring the surroundings of automated transit vehicles using OBU vision sensors. In some embodiments, special sensing methods for non-dedicated lanes comprise collecting information, processing information, processing information, fusing information, sending information to the TCC/TCU network, and/or sharing information through the cloud platform.

In some embodiments, the transit management system is configured to perform special sensing methods at transit stations comprising monitoring passenger behavior and transit vehicles using RSU in the transit station. In some embodiments, the transit management system is configured to perform special sensing methods at an intersection comprising monitoring pedestrians and vehicles using RSU installed at the intersection. In some embodiments, the transit management system is configured to perform special sensing methods at the entrance of a dedicated lane comprising detecting and recording non-automated vehicles by entrance sensors, tracking said non-automated vehicles using RSU, and notifying vehicles with messages indicating the presence of a non-automated vehicle. In some embodiments, the transit management system is configured to perform special sensing methods for automated transit vehicles comprising monitoring vehicle status and passenger status and sending vehicle status and passenger status information to RSU. In some embodiments, the transit management system is configured to perform methods for managing a transit related emergency, incident, safety, or security incident. In some embodiments, transit related emergency, incident, safety, or security incident is a sick passenger, vehicle catching fire, and/or vehicle broken down. In some embodiments, the methods comprise detecting and identifying events by an OBUs and/or RSU; sending events information to a TOC and/or cloud-based platform; analyzing and evaluating events by TOC and cloud system using site-specific road environment information; producing strategies for managing said transit related emergency, incident, safety, or security incident and for controlling a transit vehicle by TOC and sending said strategies to cloud-based platform and/or TCC/TCU network; sending warning information to transit users using the cloud system and/or RSUs; updating a scheduling and dispatching plan and sending the updated plat to transit vehicles using the cloud-based platform; guiding passengers on the affected transit vehicle to evacuate using OBUs and RSUs; controlling transit vehicle(s) involved in the event to a safe stop using RSU, TCC/TCU network, and cloud services; and monitoring and tracking passengers and transit vehicles involved in the events by OBUs and/or RSUs until the event clears.

In some embodiments, the transit management system is configured to perform transportation behavior prediction and management methods at a microscopic, mesoscopic, and/or macroscopic level. In some embodiments, microscopic transportation behavior prediction and management methods comprise managing longitudinal and lateral control of transit vehicles. In some embodiments, longitudinal control of transit vehicles comprises determining a bus following distance. In some embodiments, lateral control of transit vehicles comprises staying in a lane and/or changing lanes. In some embodiments, mesoscopic transportation behavior prediction and management methods comprise detecting an incident, providing weather forecast, and/or managing transit vehicle speed. In some embodiments, detecting an incident comprises monitoring the status of tires, braking components, and sensors. In some embodiments, providing a weather forecast comprises managing communication between the transit vehicle and a component configured to provide weather forecasting. In some embodiments, said component configured to provide weather forecasting is configured to perform cloud map analysis and machine learning, refresh weather information, and improve the accuracy of weather forecasting. In some embodiments, managing transit vehicle speed comprises determining the location of a reduced speed zone and reducing the driving speed. In some embodiments, macroscopic transportation behavior prediction and management methods comprise managing route planning and guidance. In some embodiments, managing route planning and guidance comprises determining a route and travel time for a transit vehicle using information describing a departure point and destination for said transit vehicle. In some embodiments, macroscopic transportation behavior prediction and management methods comprise managing network demand. In some embodiments, managing network demand comprises reading and analyzing images and video data using cloud storage and computing. In some embodiments, managing network demand comprises use of video monitoring, traffic information control system, guidance system, and traffic flow forecasting system.

In some embodiments, the transit management system is configured to perform planning and decision making methods at a microscopic, mesoscopic, and/or macroscopic level. In some embodiments, microscopic planning and decision making methods comprise managing longitudinal and lateral control of transit vehicles. In some embodiments, longitudinal control of transit vehicles comprises determining a car following distance, acceleration, and deceleration. In some embodiments, lateral control of transit vehicles comprises staying in a lane or changing lanes. In some embodiments, mesoscopic planning and decision making methods comprise managing vehicle movement to comply with rules at a bus stop, intersection, ramp interchange, work zone, and/or reduced speed zone. In some embodiments, rules are permanent or are temporary. In some embodiments, mesoscopic planning and decision making methods comprise managing vehicle movement to comply with a special event notification, traffic incident, buffer space notification, and/or weather forecast notification. In some embodiments, macroscopic planning and decision making methods comprise planning a route, providing guidance for a route, and managing network demand.

In some embodiments, the transit management system is configured to us detection, warning, and control methods for CATVs in specific road scenarios. In some embodiments, a road scenario comprises one or more dedicated lane(s) shared by automated transit vehicles. In some embodiments, automated transit vehicles comprise customized mobility service vehicles and non-customized mobility service vehicles. In some embodiments, a road scenario comprises time-sharing dedicated lane(s) for automated transit vehicles, wherein RSU detects automated transit vehicles and non-automated transit vehicles and sends commands to automated transit vehicles via I2V. In some embodiments, a road scenario comprises one or more non-dedicated lane(s) shared by automated and human driven vehicles.

In some embodiments, the transit management system is configured as an open platform. In some embodiments, the open platform is configured to manage information inquiries from passengers and managers; provide a customized mobility automated drive service; provide a laws and regulations service (e.g., for managing compliance of the CAVH with rules, laws, and regulations); coordinate aid services with other entities; broadcast information and messages; and/or manage users.

In some embodiments, the transit management system is configured to provide safety and efficiency measures for CATV operations and control under adverse weather conditions. In some embodiments, safety and efficiency measures for CATV operations and control under adverse weather conditions comprise a location service provided by local RSU; site-specific road weather and pavement condition information service provided by RSUs supported by the TCC/TCU network and the cloud services; Transit vehicle control service for adverse weather conditions; and/or Transit vehicle routing and schedule service supported by site-specific road weather information. In some embodiments, the RSU provides said location service without the support of vehicle-based sensors. In some embodiments, the RSU provides information comprising lane width, lane approach, grade, curvature, and other road geometric information. In some embodiments, the lane approach is left, through, or right.

In some embodiments, the transit management system is configured to provide security functions. In some embodiments, the transit management system is configured to perform methods for hardware security, network and data security, and reliability and resistance. In some embodiments, hardware security methods provide a safe work environment for the systems. In some embodiments, hardware security methods comprise guarding against theft and destruction, preventing information leakage, protecting power supply, and shielding against electromagnetic interference. In some embodiments, network and data security methods provide communication and data safety for the CAVH system. In some embodiments, network and data security methods comprise monitoring and self-examining the system, managing firewalls between data interfaces, encrypting transmitted data, recovering data, and providing multiple transmission methods. In some embodiments, reliability and resilience methods provide system recovery and function redundancy for minimizing and/or eliminating effects of unexpected system failures. In some embodiments, reliability and resilience methods comprise managing a dual boot system, providing monitoring and reporting of data errors, correcting data, and/or retransmitting corrected data automatically.

In some embodiments, the transit management system is configured to perform a blind spot detection method for transit vehicles. In some embodiments, blind spot detection methods for transit vehicles comprises methods for dedicated lanes and non-dedicated lanes. In some embodiments, methods for dedicated lanes comprise fusing heterogeneous data by a RSU, wherein said data are collected by RSU, OBU and other sources. In some embodiments, fusing heterogeneous data provides a road and vehicles environmental status for transit vehicles to cover the blind spots, wherein said road and vehicles environmental status is provided by fusing heterogeneous data by a RSU, wherein said data are collected by RSU, OBU and other sources. In some embodiments, methods for non-dedicated lanes comprise detecting obstacles around automated vehicles using an RSU and/or OBU, detecting obstacle around non-automated vehicles using an RSU and/or OBU, and detecting moving entities on the road side using an RSU and/or OBU. In some embodiments, methods for non-dedicated lanes comprise using road and vehicles environmental status to control connected and automated transit vehicles. In some embodiments, the transit management system is configured to resolve conflicts in data collected by the RSU and OBU using an assigned confidence of each data source to determine the final outputs. In some embodiments, road and vehicles environmental status are sent to a display screen in the transit vehicle for a driver to observe the environment around the vehicle.

Also provided herein are methods employing any of the systems described herein for the management of one or more aspects of traffic control. The methods include those processes undertaken by individual participants in the system (e.g., drivers, public or private local, regional, or national transportation facilitators, government agencies, etc.) as well as collective activities of one or more participants working in coordination or independently from each other.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings:

FIG. 1 shows the two examples of bus stops, e.g., bus bay stop and curbside stop. 101: Bus bay stop; 102: Curbside stop; 103: RSU; 104: Bus only lane.

FIG. 2 shows non-dedicated lanes for mixed traffic, e.g., including car, bus, and minibus. 201: Non-dedicated lane; 202: RSU.

FIG. 3 shows an example of dedicated CATV lane used by CATV. 301: Dedicated CATV lane; 302: Non-dedicated lane; 303: RSU.

FIG. 4 shows an example of peak-hour CATV-only lane. 401: Peak-hour CATV-only lane; 402: Non-dedicated lane; 403: RSU.

FIG. 5 shows controlling the level of priority at intersections or diverging/merging areas.

FIG. 6 shows content that the CATVs send to road controllers via I2V communication.

FIG. 7 shows a flow diagram for transit stop management and control.

FIG. 8 is a schematic diagram showing entering and exiting to a CATV station.

FIG. 9 is a flow chart for entrance control.

FIG. 10 is a flow chart for exit control.

FIG. 11 shows the network and architecture of TCC and TCU.

FIG. 12 shows the modules of TCCs and the relationship between these modules.

FIG. 13 shows the modules of TCUs and the relationship between these modules.

FIG. 14 is a flowchart of input-output for non-customized shuttle bus.

FIG. 15 is flowchart of input-output for customized shuttle bus.

FIG. 16 shows the architecture of OBU, e.g., comprising communication module, data collection module, transit vehicle control module, and data flow between OBU, Vehicle, and RSU. 1701: Communication module, e.g., configured to transfer data between RSU and OBU; 1702: Data collection module, e.g., configured to collect data of the transit vehicles. 1703: Transit vehicle control module, e.g., configured to execute control command from RSU.

FIG. 17 shows the architecture of the CAVH cloud platform.

FIG. 18 shows management processes for transit related emergency, incident, safety, and security events.

FIG. 19 shows the warning and control methods for road scenes.

FIG. 20 shows an example of a transit line customizing platform.

FIG. 21 is a schematic drawing showing Transit Vehicle Operation and Control in Adverse Weather. 2101: wide area weather and traffic information obtained by the TCU/TCC network; 2102: comprehensive weather and pavement condition data and vehicle control instructions; 2103: transit vehicle status, location and sensor data; 2104: Transit service information in adverse weather.

### DETAILED DESCRIPTION

In some embodiments, the present technology relates generally to a comprehensive system providing full vehicle operations and control for connected and automated transit vehicles, and, more particularly, to a system controlling CATVs by sending individual vehicles with detailed and time-sensitive control instructions for vehicle routing, lane changing, turning, and related information. In some embodiments, the technology provides a system for controlling CAVs by sending customized, detailed, and time-sensitive control instructions and traffic information for automated vehicle driving to individual vehicles, such as vehicle following, lane changing, route guidance, and other related information (e.g., a CAVH system (e.g., as described in U.S. patent application Ser. No. 15/628,331, filed Jun. 20, 2017 and U.S. Provisional Patent Application Ser. No. 62/626,862, filed Feb. 6, 2018, U.S. Provisional Patent Application Ser. No. 62/627,005, filed Feb. 6, 2018, U.S. Provisional Patent Application Ser. No. 62/655,651, filed Apr. 10, 2018, and U.S. Provisional Patent Application Ser. No. 62/669,215, filed May 9, 2018, the disclosures of which are herein incorporated by reference in their entireties)). In some embodiments, the technology comprises a cloud system as described in U.S. Provisional Patent Application Ser. No. 62/691,391, incorporated herein by reference in its entirety. In some embodiments, the technology comprises technologies related to safety systems as described in U.S. Provisional Patent Application Ser. No. 62/695,938, incorporated herein by reference in its entirety. In some embodiments, the technology relates to the use of a connected automated vehicle highway system and methods and/or components thereof for heavy and special vehicles, e.g., as described in U.S. Provisional Patent Application Ser. No. 62/687,435, filed Jun. 20, 2018, which is incorporated herein by reference. In some embodiments, the technology comprises technologies related to an on-board unit (OBU) for a vehicle as described in U.S. Provisional Patent Application Ser. No. 62/695,964, incorporated herein by reference in its entirety.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “sensing-free” method does not comprise a sensing step, a “controller-free” system does not comprise a controller, etc.

As used herein, the term “support” when used in reference to one or more components of the CAVH system providing support to and/or supporting one or more other components of the CAVH system refers to, e.g., exchange of information and/or data between components and/or levels of the CAVH system, sending and/or receiving instructions between components and/or levels of the CAVH system, and/or other interaction between components and/or levels of the CAVH system that provide functions such as information exchange, data transfer, messaging, and/or alerting.

### Description

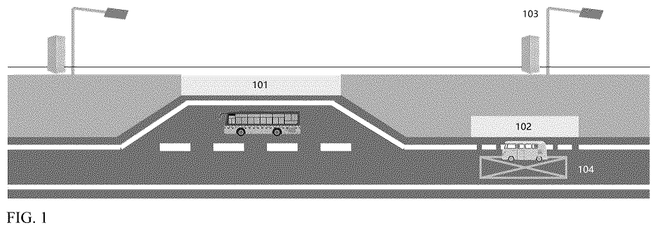

FIG. 1 shows two examples of bus stops, a bus bay stop and a curbside stop. The bus stops can be located at near-side location, far-side location, or mid-block location. The bus bay stop 101 can be used by bus and minibus, while the curbside stop 102 is only for minibus. Moreover, other vehicles cannot be parked by bus stop or other areas marked by yellow pavement markings.

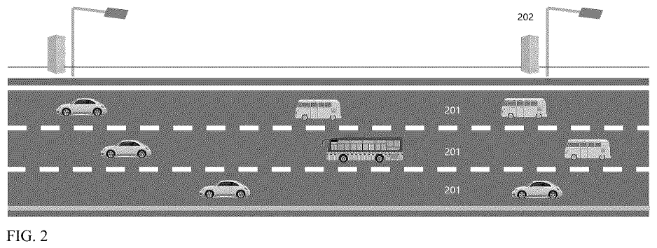

FIG. 2 shows that there are only non-dedicated lanes 201 for mixed traffic which include car, bus, and minibus. The RSU sensing module 202 are used to identify vehicles that meet the requirement of Infrastructure-to-Vehicle (I2V) communication. Generally, the only non-dedicated lanes are appropriate for road having few bus routes (usually less than 3).

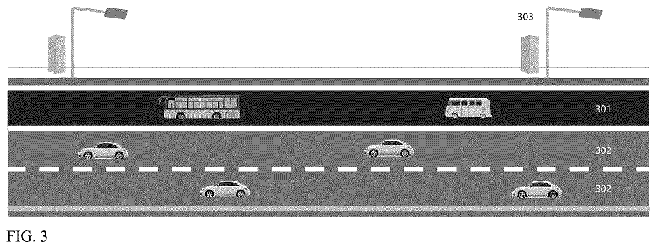

FIG. 3 shows the example of a dedicated CATV lane 301 which is used by CATV only. The dedicated CATV lane 301 is on the right side and the non-dedicated lane 302 is on the left side. Generally, the dedicated CATV lane is appropriate for roads having many bus routes (usually more than 5).

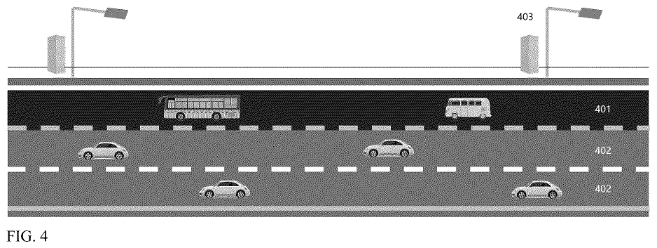

FIG. 4 shows the example of peak-hour CATV-only lane 401, which is used by CATV only during the peak hours, while the peak-hour CATV-only lane 401 can also be used by mix traffic during the off-peak hours. The peak-hour is a part of the day which the volume of traffic is at its highest. Although peak-hour periods may vary from city to city, region to region, and seasonally, they are usually 7-9 am and 5-7 pm. The peak-hour CATV-only lane 401 is on the right side and the non-dedicated lane 402 is on the left side.

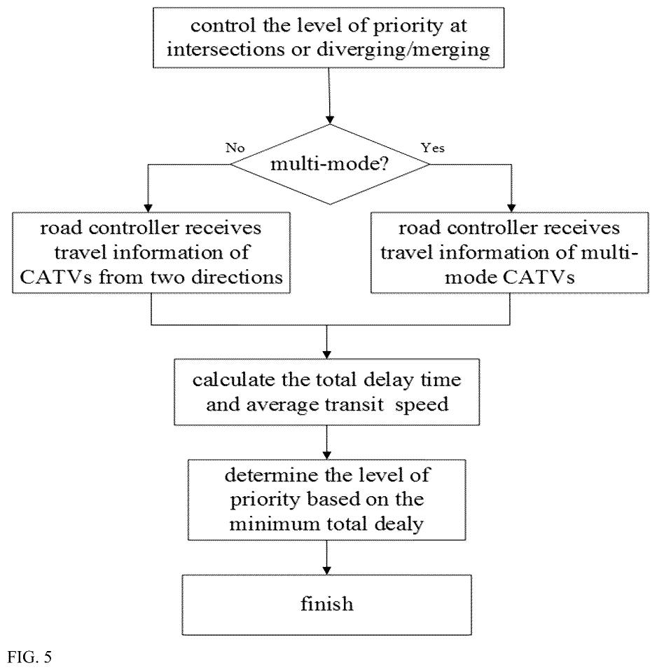

FIG. 5 shows how to control the level of priority at intersections or diverging/merging areas. There are two types of level of priority. One is the level of priority among different CATVs modes. The other level of priority is the level of priority between CATVs from two directions at the intersections or the diverging/merging areas. Therefore, in the first step, the controller needs to determine whether it is the level of priority among different CATVs modes or not. If it is the level of priority among different CATVs modes, the road controller will receive the travel information of these multi-mode CATVs. Then the total delay time caused by these multi-mode CATVs will be calculated. Moreover, the average speed of these multi-mode CATVs will be also calculated. After that, the level of priority will be determined based on the minimum total delay. When it is the level of priority between CATVs from two directions at the intersections or the diverging/merging areas, the travel information of the CATVs from the two directions will be sent to the road controller. Then their total delay time and average speed will be calculated, based which the level of priority will be determined.

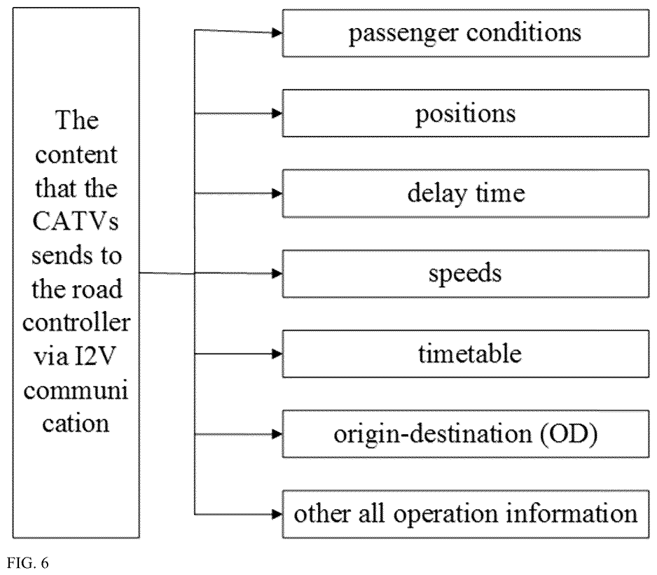

FIG. 6 shows the content that the CATVs send to the road controller via I2V communication. When the CATVs travel on the road, they report their driving operations to the road controller. The content that the CATVs send to the road controller include passenger conditions, positions, delay time, speeds, timetable, origin-destination (OD), and other operation information. Passenger conditions include whether there are some emergencies in the vehicle and whether the passengers are safe. Positions and speeds mean the trajectories of the CATVs with the time. Delay time means the time that the CATVs cause if it exists. Timetable means station information of the CATVs, while origin-destination (OD) means the starting and ending stations.

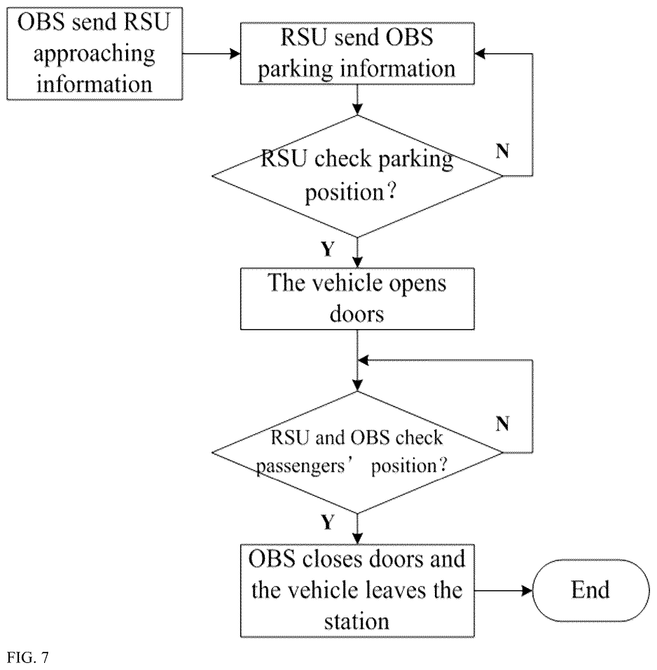

FIG. 7 shows the flow diagram of the transit stop management and control, which includes steps as the following: 1) RSU receives the automated transit vehicle entry information in advance and sends the stop position information to the approaching vehicle; 2) After RSU confirms that the vehicle is parked in the correct position, the bus will open the entrance and exit doors; 3) When OBS detects the end of the passengers' getting off, and RSU detects that the passengers off the bus meets the safety distance from the vehicle door, the exit door is closed; 4) When OBS detects the end of the passengers' boarding and the passengers meet the safety distance from the vehicle door, the entrance door is closed; 5) When OBS detects that all passengers in the vehicle reach the safe area, and RSU detects that all passengers on the platform reach the safe area, the automated transit vehicle starts the outbound mode and leaves the platform.

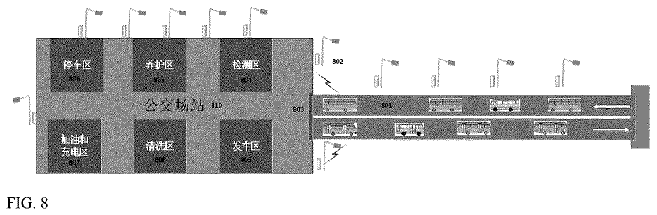

FIG. 8 shows how automated transit vehicles enter and exit a CATV station. When entering, the RSU guides the automated transit vehicle from the Dedicated CATV lane to the CATV station, the access control system identifies vehicle, releases CATV and intercepts other vehicles through the RFID technology. Then, the automated transit vehicle enters the vehicle inspection area, the vehicle is determined whether need maintenance, cleaning, or refueling by the vehicle status. If needed, the RSU plans a detailed path for the vehicle and guides it to the appropriate area. After the operation process is completed, the RSU guides the vehicle into the parking area. If unnecessary, the RSU guides the vehicle into the parking area directly. When exiting, the RSU sends instructions to the automated transit vehicle in the parking area according to the bus schedule, and guides it to the departure area waiting. At the time of departure, the RSU guides the bus from the departure area to the entrance guard, and the RFID is used to identify the vehicle and release the required autonomous bus.

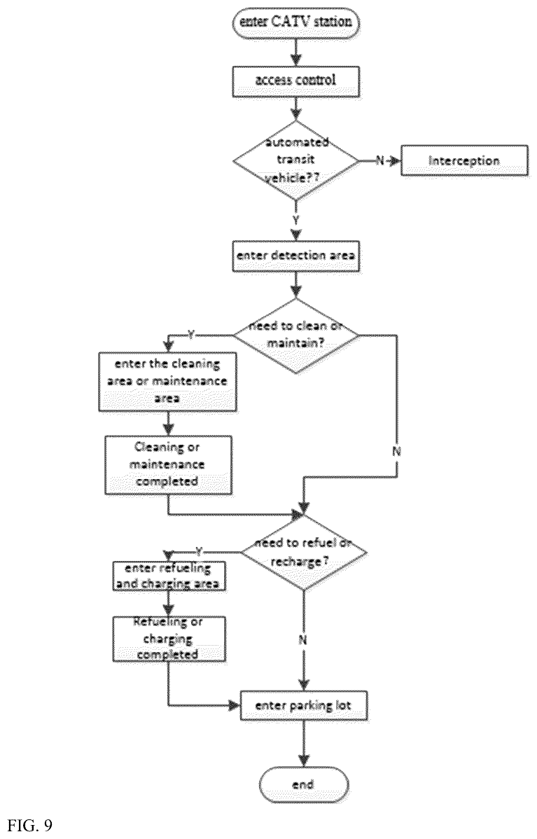

FIG. 9 shows a flow chart of the automated transit vehicle of entering the CATV station. The RSU guides the automated transit vehicle from the Dedicated CATV lane to the CATV station, the access control system identifies vehicle, releases CATV and intercepts other vehicles through the RFID technology. Then, the automated transit vehicle enters the vehicle inspection area, the vehicle is determined whether need maintenance, cleaning or refueling by the vehicle status. If needed, the RSU plans a detailed path for the vehicle, guides it to the appropriate area. After the operation process is completed, the RSU guides the vehicle into the parking area. If unnecessary, the RSU guides the vehicle into the parking area directly.

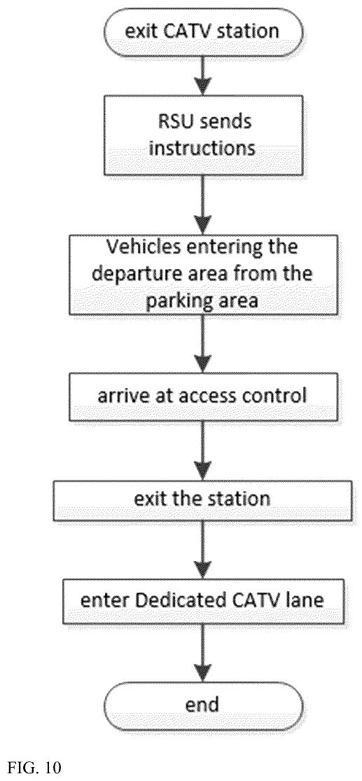

FIG. 10 shows a flow chart of the automated transit vehicle of exiting the CATV station. The RSU sends instructions to the automated transit vehicle in the parking area according to the bus schedule, and guides it to the departure area waiting. At the time of departure, the RSU guides the bus from the departure area to the entrance guard, and the RFID is used to identify the vehicle and release the required autonomous bus.

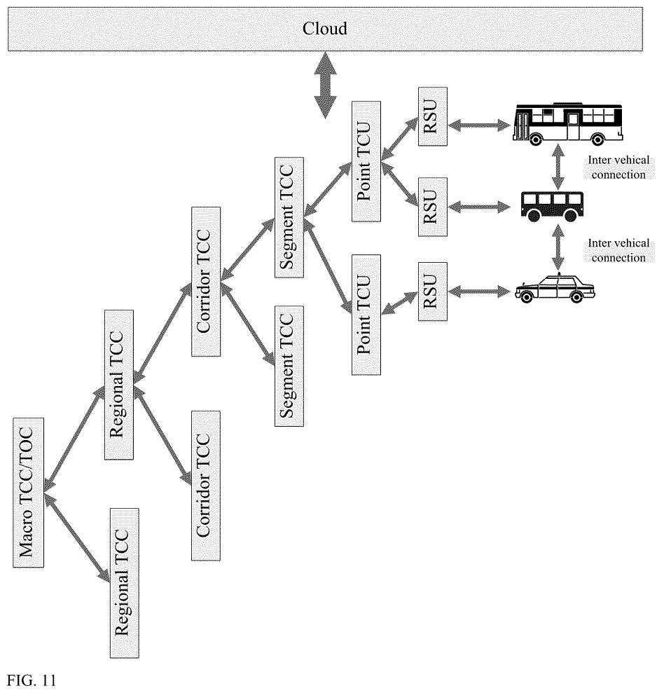

FIG. 11 shows the network and architecture of TCC and TCU. The TCCs and TCUs show a hierarchical structure, and are connected with cloud. Form the top to the bottom, there are several levels of TCC including Macro TCCs, Regional TCCs, Corridor TCCs, and Segment TCCs. The up-lever TCCs control their subordinate TCCs, and data is exchanged between the TCCs of different levels. The TCCs and TCUs show a hierarchical structure, and are connected with cloud. The cloud connects all provide data platform and various software for all the TCCs and TCUs, and provide the integrated control functions. Under the point TCUs, the RSUs provide transit with customized traffic information and control instructions, and receive information from transit vehicles.

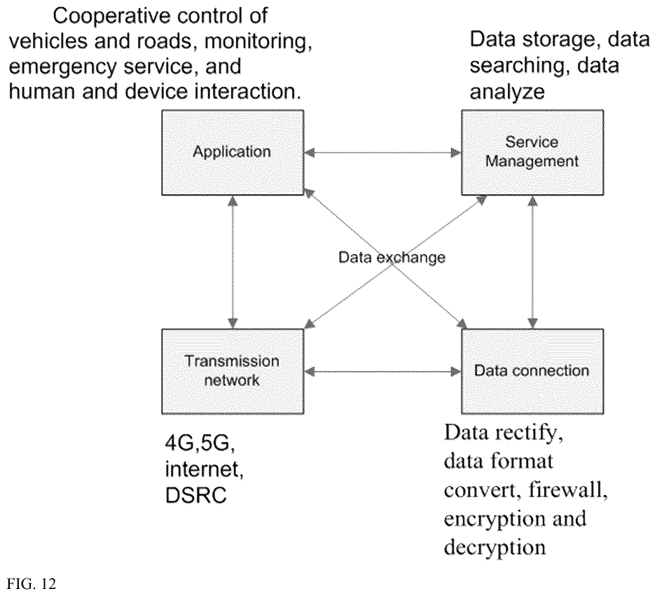

FIG. 12 shows the modules of TCCs and the relationship between these modules. There are four modules, the application module, the service management module, the transmission and network module, and the data connection module. Each module is connected the other three modules, and data exchange is performed between these modules to realize the functions of TCCs. The functions of the application module include cooperative control of transit vehicles and roads, monitoring, emergency service, and human and device interaction. The functions of the service management include data storage, data searching, and data analysis. The functions of the transmission network include 4G, 5G, internet, and DSRC transmission methods. The functions of the Data connection include data rectify, data format convert, firewall, encryption and decryption.

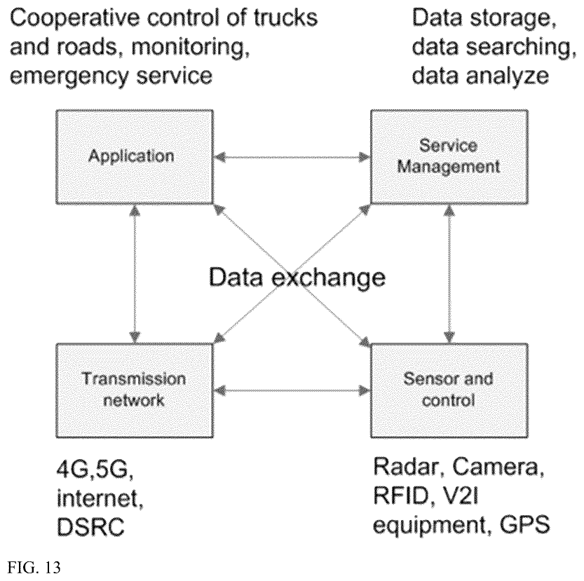

FIG. 13 shows the modules of TCUs and the relationship between these modules. Form the top to the bottom; they are application module, service management module, transmission and network module, and hardware module. Data exchange is performed between these modules to realize the functions of TCUs. The functions of the application module include cooperative control of transit vehicles and roads, monitoring, and emergency service. The functions of the service management module include data storage, data searching, and data analysis. The functions of the transmission network include 4G, 5G, internet, and DSRC transmission methods. The functions of the sensor and control module include radar, camera, RFID, V2I equipment, and GPS.

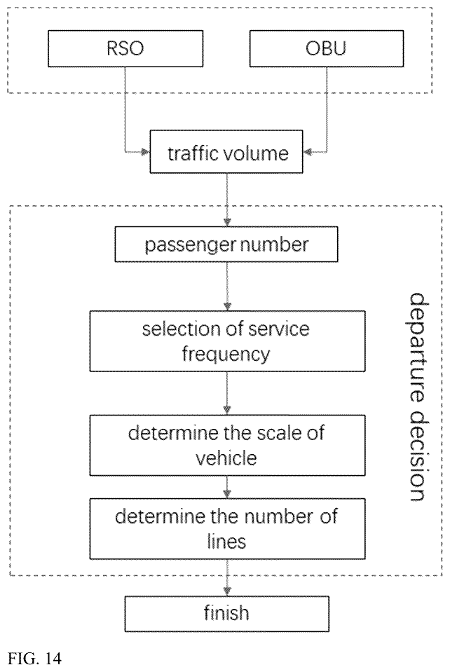

FIG. 14 shows determining traffic volume and predicting the number of passengers based on the traffic volume using data collected by RSO and OBU. The technology selects service frequency and determines the scale of vehicle according to the number of passengers. Though it is best to provide a high frequency service to reduce the time for passenger waiting, if the dispatch interval is too small and the frequency is too high, there may be a danger of causing traffic congestion and reducing operating speed. The technology, in some embodiments, comprises confirming the number of lines.

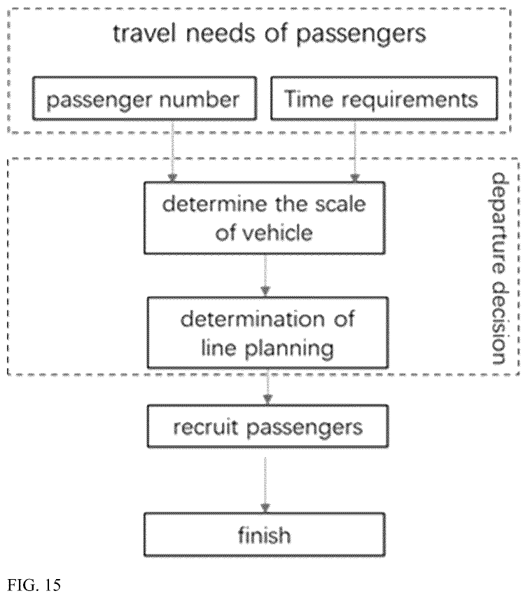

FIG. 15 shows a flowchart for the input-output of a customized shuttle bus. The technology determines passenger demand (e.g., including passenger number), whether the ride is a one-way bus ride or round trip, the time requirements for return, the scale of the vehicle, and designs the optimal route according to the passenger flow. Then, the technology recruits, reserves, and pays for the passengers on the custom bus platform. Finally, the public transport group will start the shuttle bus according to the appointed time, location, and direction. In this process, the technology considers factors such as bus punctuality, travel time difference, travel cost, and efficiency.

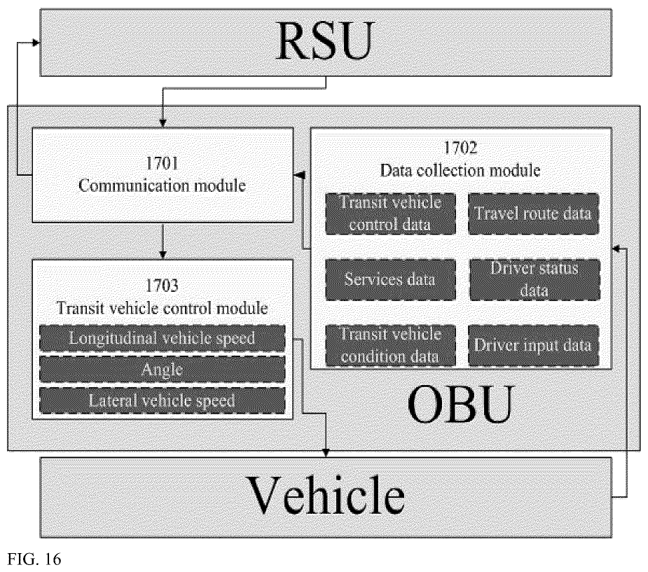

FIG. 16 shows the architecture of OBU which contains communication module, data collection module, transit vehicle control module and data flow between OBU, Vehicle, and RSU.

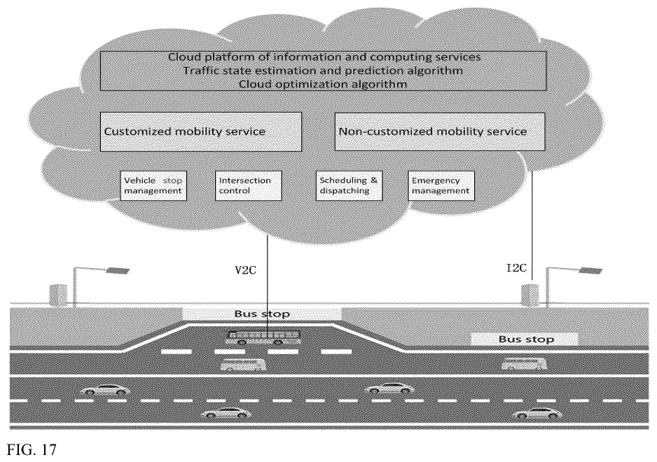

FIG. 17 shows the architecture of the CAVH cloud platform, in which both customized mobility service and non-customized mobility service are taken into consideration. Through the cloud optimization algorithm, the CAVH cloud platform provides information storage and additional sensing, computing, and control services for infrastructure and transit vehicles.

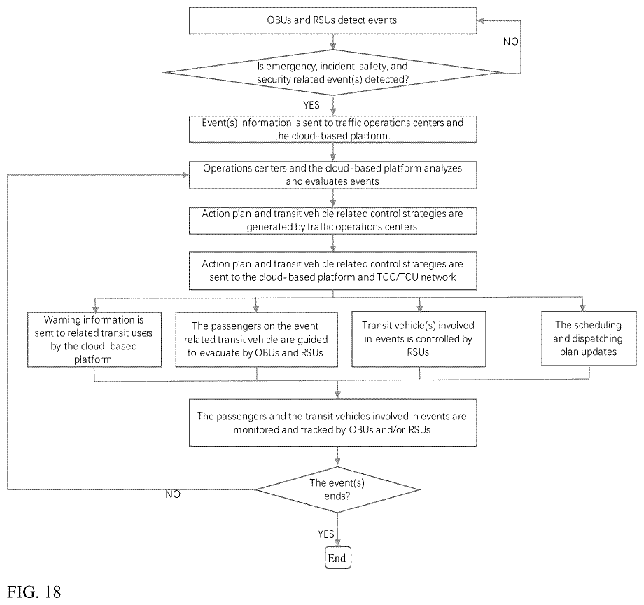

FIG. 18 shows management process of transit related emergency, incident, safety, and security events. OBUs and RSUs detect events routinely. If emergency, incident, safety, and security related event(s) is detected, event(s) information is sent to traffic operations centers and the cloud-based platform. Operations centers and the cloud-based platform analyzes and evaluates events immediately. Action plan and transit vehicle related control strategies are generated by traffic operations centers and then sent to the cloud-based platform and TCC/TCU network. Warning information is sent to related transit users by the cloud-based platform and transit vehicle(s) involved in events is controlled by RSUs. The passengers on the event related transit vehicle are guided to evacuate by OBUs and RSUs. And the scheduling and dispatching plan updates. In the process of evacuation, the passengers and the transit vehicles involved in events are monitored and tracked by OBUs and/or RSUs. If the event(s) is detected not to end, operations center and the cloud-based platform continues to analyzes and evaluates events, or the management process of transit related emergency, incident, safety, and security events will end.

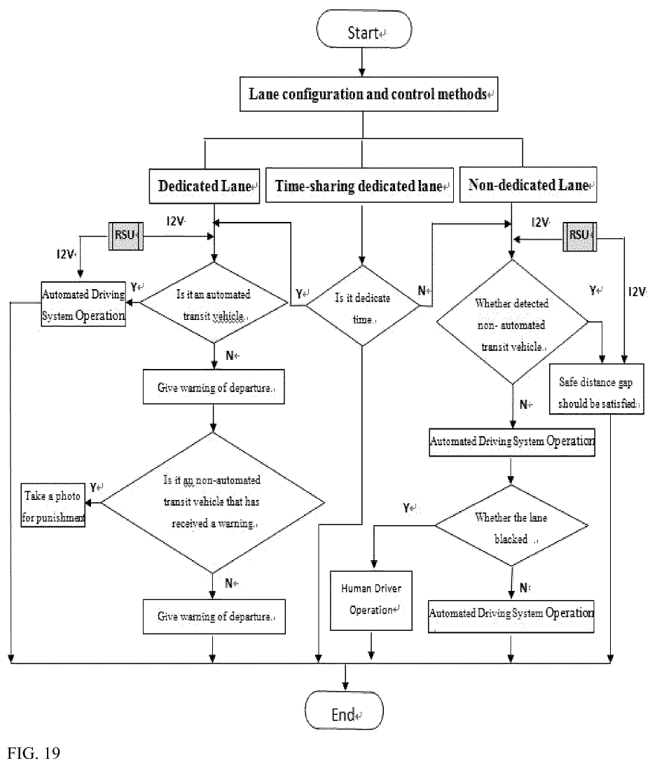

FIG. 19 shows the warning and control methods for three specific road scene. The first is the dedicated lane(s) shared by automated transit vehicles including customized mobility service and non-customized mobility service; when other vehicles such as social vehicles or non-autonomous transit vehicles driving into the lane(s), will be issued with warnings through RSU to drive off the special lanes, if an non-automated transit vehicle that has received a warning still driving on the dedicated lane(s), the RSU will take a photo for punishment; the second is the Automatic time-sharing dedicated lanes, there has two situations: it is running according to the first in the dedicated time period, and in the mixed traffic period according to the second; and the third is the mixed traffic lanes, when there have high flow pressure area and high crash road segments, the system alert the human driver to take over vehicle control, If the driver takes no action after certain amount of time, the automatic driving system controls the vehicle to a safe stop.

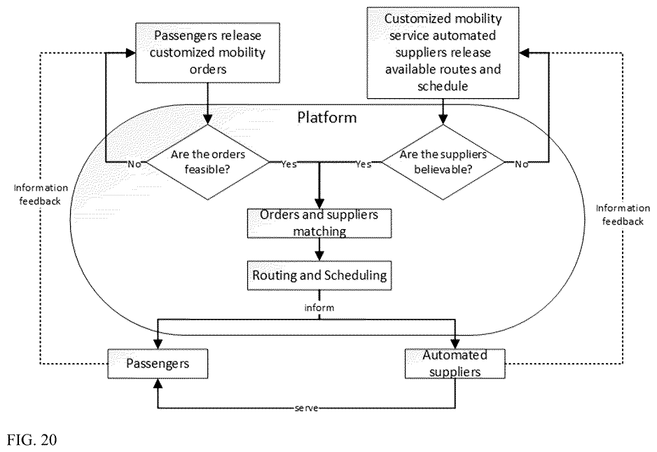

FIG. 20 shows an example of a transit line customizing platform. Passengers release customized transit orders on the platform, which including the origin and destination, time window, number of passengers and some other requirements. The customized mobility automated drive service suppliers release their available routes and schedule on the platform. The platform evaluates the orders and the suppliers separately. When the orders are feasible and the suppliers are believable, they are matched, and the routing and scheduling are computed by the optimization algorithms. Then the platform informs the passengers and automated suppliers of the routing and scheduling. The suppliers serve the passengers according to the schedule. After each service, the suppliers and passengers feedback the service quality and problems to the platform, which are used to improve the management of the platform.

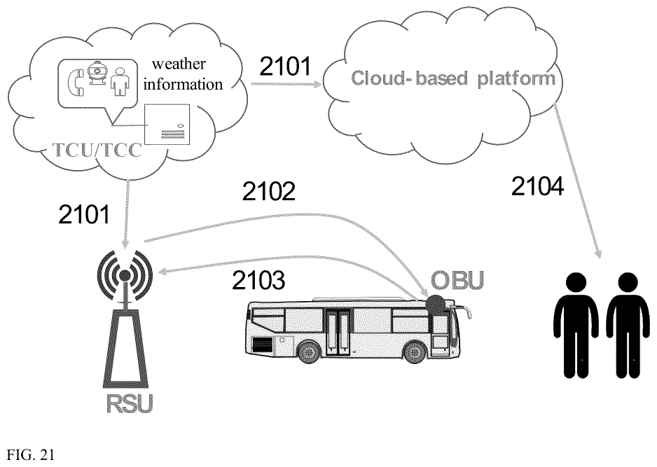

FIG. 21 shows an example of transit vehicle operation and control in adverse weather. Transit vehicle status, location and sensor data is sent to RSU in real time. Once the TCU/TCC receives the adverse weather information, it will send the wide area weather and traffic information to RSU and Cloud-based platform. In one hand, RSU will send the comprehensive weather and pavement condition data, vehicle control, routing and schedule instructions to OBUs installed in transit vehicles. In the other hand, Cloud-based platform will send according transit service information in adverse weather to related passengers.

1-159. (canceled)

160. A transit operations system for operating a connected and automated transit vehicle (CATV), said transit operations system comprising an onboard unit (OBU) provided in a CATV and said OBU comprising:
a communication module communicating with one or more of: (a) other vehicles, (b) roadside units (RSUs), (c) a cloud-based platform, or (d) a traffic control center or traffic control unit (TCC/TCU);
a sensing module monitoring the surroundings of the CATV;
a data collection module configured to collect data from the CATV and to monitor the status of the CATV, passengers, and drivers; and
a vehicle control module configured to execute control instructions,
wherein:
said OBU receives site specific weather information using said communication module;
said transit operations system is configured to perform a transportation behavior prediction and management method at a microscopic and mesoscopic level, wherein said mesoscopic transportation behavior prediction and management method comprises providing a weather forecast and managing the CATV speed and said microscopic transportation behavior prediction and management method comprises managing longitudinal and lateral control of said CATV; and
said transit operations system is configured to provide safety and efficiency measures for vehicle operations and control under adverse weather conditions, and wherein the safety and efficiency measures for vehicle operations and control comprise a location service provided by a roadside unit (RSU) and site-specific road weather and pavement condition information service provided by the RSU.

161. The transit operations system of claim 160, wherein providing a weather forecast comprises managing communication between the CATV and a component configured to provide weather forecasting.

162. The transit operations system of claim 161, wherein said component configured to provide weather forecasting is configured to perform cloud map analysis and machine learning, refresh weather information, and improve the accuracy of weather forecasting.

163. The transit operations system of claim 160, wherein said mesoscopic planning and decision making method comprises managing vehicle movement to comply with a weather forecast notification.

164. The transit operations system of claim 160, wherein said longitudinal control of the CATV comprises determining a following distance and said lateral control of the CATV comprises staying in a lane and/or changing lanes.

165. The transit operations system of claim 160, wherein an RSU is deployed at a location of extreme weather.

166. The transit operations system of claim 160, wherein an RSU is deployed on a vehicle drone or an unmanned aerial vehicle (UAV) at a site of extreme weather.

167. A transit operations system for operating a connected and automated transit vehicle (CATV), said transit operations system comprising an onboard unit (OBU) provided in a CATV and said OBU comprising:
a communication module communicating with one or more of: (a) other vehicles, (b) roadside units (RSUs), (c) a cloud-based platform, or (d) a traffic control center or traffic control unit (TCC/TCU);
a sensing module monitoring the surroundings of the CATV;
a data collection module configured to collect data from the CATV and to monitor the status of the CATV, passengers, and drivers; and
a vehicle control module configured to execute control instructions,
wherein:
said OBU receives site specific weather information using said communication module;
said transit operations system is configured to perform a transportation behavior prediction and management method at a microscopic and mesoscopic level, wherein said mesoscopic transportation behavior prediction and management method comprises providing a weather forecast and managing the CATV speed and said microscopic transportation behavior prediction and management method comprises managing longitudinal and lateral control of the CATV; and
said transit operations system is configured to perform a special sensing method at an intersection, said special sensing method comprising monitoring pedestrians and vehicles.

168. The transit operations system of claim 167, wherein monitoring pedestrians and vehicles is provided using a roadside unit (RSU) installed at the intersection.

169. The transit operations system of claim 167, further comprising an intersection management module configured to monitor pedestrians and control a CATV based on traffic conditions at intersections.

170. The transit operations system of claim 167, wherein RSUs are deployed according to spacing and layout factors comprising road environment and pedestrian movement.

171. The transit operations system of claim 167, wherein providing a weather forecast comprises managing communication between the CATV and a component configured to provide weather forecasting.

172. The transit operations system of claim 171, wherein said component configured to provide weather forecasting is configured to perform cloud map analysis and machine learning, refresh weather information, and improve the accuracy of weather forecasting.

173. The transit operations system of claim 167, wherein said mesoscopic planning and decision making method comprises managing vehicle movement to comply with a weather forecast notification.

174. A transit operations system configured to provide integrated operations and controls for a connected and automated transit vehicle (CATV), said transit operations system configured to provide safety and efficiency measures for vehicle operations and control under adverse weather conditions, wherein said safety and efficiency measures comprise:
a) a location service provided by a roadside unit (RSU);
b) a site-specific road weather and pavement condition information service provided by RSUs supported by a traffic control center/traffic control unit (TCC/TCU) network and a cloud service;
c) a CATV control service for adverse weather conditions; and
d) a transit vehicle routing and schedule service supported by site-specific road weather information.

175. The transit operations system of claim 174, wherein the RSU is deployed on a vehicle drone or an unmanned aerial vehicle (UAV) at a site of extreme weather.

176. The transit operations system of claim 174, configured to perform a transportation behavior prediction and management method at a microscopic and mesoscopic level, wherein
said mesoscopic transportation behavior prediction and management method comprises providing a weather forecast and managing the CATV speed; and
said microscopic transportation behavior prediction and management method comprises managing longitudinal and lateral control of said CATV.

177. The transit operations system of claim 176, wherein said mesoscopic transportation behavior prediction and management method comprises providing a weather forecast and managing the CATV speed.

178. The transit operations system of claim 176, wherein providing a weather forecast comprises managing communication between the CATV and a component configured to provide weather forecasting.

179. The transit operations system of claim 178, wherein said component configured to provide weather forecasting is configured to perform cloud map analysis and machine learning, refresh weather information, and improve the accuracy of weather forecasting.
